(19) United States
(12) Patent Application Publication
(10) Pub. No.: US 2016/0243791 A1
(43) Pub. Date: Aug. 25, 2016

(54) BONDED ASSEMBLY PROVIDED WITH A INTERMEDIATE DEFORMATION LAYER WITH VARIABLE FLEXIBILITY

(71) Applicant: COLD PAD, Paris (FR)

(72) Inventor: Jean-Philippe COURT, Paris (FR)

(21) Appl. No.: 15/030,651

(22) PCT Filed: Oct. 20, 2014
(86) PCT No.: PCT/FR2014/052664

§ 371 Date: Apr. 20, 2016

(30) Foreign Application Priority Data
Oct. 21, 2013 (FR) 13 60239

(51) Int. Cl. B32B 7/02; B32B 37/14; B32B 7/12; B32B 5/14; B32B 3/26

(52) U.S. Cl. CPC B32B 7/02; B32B 5/142; B32B 3/263; B32B 7/12; B32B 37/144; B32B 2307/54; B32B 2307/546; B32B 2419/00

(57) ABSTRACT

A bonded assembly designed for assembling a substrate to a structure or indeed to reinforce a structure. The bonded assembly includes:
first and second substrates,
an intermediate layer rigidly connected to the first substrate, and having flexibility that varies along the first substrate, the variable flexibility resulting from a variation in the thickness of at least one material of the intermediate layer,
an adhesive between the intermediate layer and the second substrate.

### TECHNICAL FIELD

This invention relates to the techniques of carrying out bonded assemblies.

It has applications in highly varied fields among which can be mentioned the connecting of an element to a substrate, in particular to a substrate whereon no attaching element has been initially provided, or the reinforcing of structures that need to be made more resistant in order to repair or prevent the appearance of structural defects.

### PRIOR ART

In the field of bonded assemblies, an adhesive can be used in order to rigidly connect at least two substrates. This is the case in particular in solutions for reinforcing structures, often carried out by applying a metal or composite reinforcement (first substrate) onto the structure (second substrate) by the intermediary of the adhesive. The adhesive can be a resin and is generally arranged at the contacts of two substrates in order to provide a mechanical maintaining of one with the other, as such forming a bonded assembly.

However, the bonded assembly can be subjected to outside forces, causing in particular differential deformations between the substrates. For this purpose, it is generally suitable that the adhesive provides at least two functions:
adhere to each one of the two substrates (first function desired) and
absorb the stresses inherent to the differential deformations (second function subjected to).

FIG. 1A shows an example of a conventional bonded assembly ACC comprising a first substrate S1 and a second substrate S2, said substrates are rigidly connected by the intermediary of a conventional adhesive ADC. Marks A and B are shown in the corners of the adhesive ADC in order to observe hereinafter an example of deformation underwent by the adhesive.

FIG. 1B shows an example of a cross-section view of the bonded assembly ACC when the latter is subjected to forces F of deformation (for example opposite forces applied respectively to the substrates S1 and S2). The adhesive ADC is deformed under the influence of stresses imposed by the forces F. The most pronounced deformations usually appear at the edges of the adhesive ADC.

FIG. 1C shows an example of the change in the shearing stresses τ, inherent to the forces F applied, underwent by the adhesive ADC between the marks A and B. The differential displacements of the substrates S1 and S2 generate shearing and peeling stresses that are high in particular in the region of the edges of the adhesive ADC. On the other hand, note that the adhesive ADC has very little, and even in certain cases no, stress in a central zone between the marks A and B.

It is understood that a correlation exists between the deformation of the adhesive ADC observed in FIG. 1B and the stresses underwent by the latter as shown in FIG. 1C. This correlation is also known as the “edge effect”. The deformation and therefore the stresses located at the edges of the adhesive significantly impact the integrity of the adhesive ADC on these zones, making the bonded assembly ACC vulnerable to the various aforementioned differential deformations.

The mechanical capacities of the bonded assembly are therefore limited, and all the more so when the differential deformations to which the assembly is exposed become high.

This phenomenon also appears when the bonded assembly is intended to reinforce a structure. Indeed, the adhesive can then be subjected to deformations inherent with the movements of the structure to be reinforced.

FIGS. 2A to 2C show by way of example the first substrate S1 having for role to reinforce the second substrate S2 which can be a structure span. Note that when the second substrate S2 is subjected to deformations under the stress of forces F for example (produced by deformations of the structure typically), the adhesive absorbs at least partially the differential deformations, generating high shearing τ and peeling σ stresses on the edges of the adhesive (at the marks A and B and in their vicinity).

To reinforce the mechanical capacities of the bonded assembly limited by these localised stresses, a solution can consist in increasing the adhesion surface of the adhesive with that of the substrates, more particularly by extending the length of this surface (i.e. increasing the distance between the marks A and B). Indeed, it has been observed that with such an increase, the mechanical capacities of the bonded assembly were improved, at the least up to a certain limit.

FIG. 3 shows a graphical representation of the force F required to obtain a rupture of the adhesive, and this according to the length L of the contact surface of the adhesive with the substrates (i.e. the length separating the marks A and B). Note that the force F applied to the rupture increases linearly up to a limit value Fm which corresponds to a limit length lm starting from which the force applied for a rupture is substantially identical.

This stabilisation of the force F at the rupture starting from a certain length of adhesion surface is for the most part caused by the edge effects that persist in substantially deforming and stressing the adhesive at its edges, locally weakening the adhesive and causing it to separate from the substrates via adhesive or cohesive ruin.

In order to limit the edge effects, it may be provided to bring an additional amount of adhesive material (in the form of a bead of adhesive for example) on either side of the adhesion surface in order to improve the resistance of the adhesive at the edges. However, the application of an additional amount of material can be difficult to carry out in certain configurations, causing uncertainty as to the exact behaviour of the vicinity of the edges following the adding of adhesive. Furthermore, carrying this out is more expensive, requiring additional precautions during the installation and/or manufacturing. The benefit obtains is furthermore rather limited.

By way of example, when the adhesive is installed between a structure and a reinforcing element of the structure, the operation of adding the additional adhesive should be carried out on site, which can be restrictive or even impossible due to the outside conditions or the configuration of the structure.

Furthermore, note that the requirement for an adhesive to provide the aforementioned functions (adhesion to the substrates and absorption of deformations) can be antagonistic. Indeed, it is generally observed that the more flexible an adhesive is (i.e. better absorption capacity), the more reduced the adhesive capacities are. Generally, the stiffest adhesives procure the best adhesion capacities but are the most sensitive to deformation stresses.

### SUMMARY OF THE INVENTION

This invention improves the situation.

The invention aims to overcome some of the limitations of the aforementioned techniques and aims in particular to provide a bonded assembly that is reliable, long lasting, with improved structural capacities making it possible in particular to supporter substantial localised deformations.

For this purpose, according to a first aspect, the invention relates to a bonded assembly comprising at least:
a first and a second substrate,
an intermediate layer rigidly connected to the first substrate, and having a variable flexibility along the first substrate, with the variable flexibility resulting from a variation in the thickness of at least one material of the intermediate layer,
an adhesive between said intermediate layer and the second substrate.

The variable flexibility procures for the intermediate layer and adhesive unit, absorption capacities of the deformations that can vary along the first substrate. These flexible variations make it possible to locally control the level of deformation, and therefore the stresses.

The behaviour in deformation can in particular be controlled in such a way as to more uniformly distribute shearing and peeling stresses, which are usually located in the vicinity of the edges of the adhesive (as explained hereinabove).

As such, the local deformations are effectively absorbed by the intermediate layer of which the flexibility is controlled, with the edges of the adhesive then being less exposed to the forces generated by the outside forces applied to the bonded assembly. The edge effects are because of this particularly reduced, increasing by as much the capacities of resistance and integrity of the adhesive, and reinforcing the rigid connection of the substrates and the structural capacities of the bonded assembly. The force required to obtain a rupture is then much higher than in prior art. It is understood that the bonded assembly is as such less vulnerable to deformation forces.

Note that the flexibility of the intermediate layer, although variable, is advantageously, at all points of the layer, higher than the flexibility of the substrates and of the adhesive.

According to an embodiment, the flexibility of the intermediate layer is progressively variable along the first substrate.

According to an embodiment, the intermediate layer is made from a homogeneous material.

According to a particular advantageous embodiment, the intermediate layer has two longitudinal ends, the intermediate layer able to comprise at least:
a first portion arranged at least at one of the longitudinal ends; and
a second portion that is more rigid that the first portion between the longitudinal ends.

“Portion” means a localised part of the intermediate layer for which a desired level of flexibility was attributed at the time of manufacture.

Moreover, “longitudinal end” designates a zone that, in the direction of the length of the intermediate layer, is at the edge of this layer. This zone can for example be a zone starting from an edge of the intermediate layer, and having a length between 5 and 30% of the length of the intermediate layer.

In this embodiment, the flexible edges of the intermediate layer very particularly absorb the deformations at the edges, substantially relieve the adhesive of the shearing and peeling stresses that are usually underwent without the intermediate layer.

The intermediate layer and adhesive unit then confer robust rigid connections of the substrates.

In an advantageous embodiment, the intermediate layer can comprise at least:
a first layer and
a second layer that is more flexible than the first layer.

Furthermore, the first and second layers can be of variable thickness along the intermediate layer.

The variation in the thickness of the layers of separate flexibilities makes it possible to adjust the general flexibility of the intermediate layer and adhesive unit and to appropriate it according to the desired behaviour of the intermediate layer and adhesive unit.

The first layer can in particular have a rigidity between 1000 and 300,000 MPa and the second layer can have a rigidity between 1 and 1000 MPa.

According to a possible embodiment, the variation in the thickness of one of the first and second layers can follow a chamfered profile, and the variation in thickness of the other of the first and second layers can follow an additional profile of the chamfered profile.

In this embodiment, the chamfered and additional profiles of the first and second layers make it possible to vary the flexibility of the intermediate layer progressively along the intermediate layer. This embodiment provides good control of the behaviour in deformation and in absorption of the intermediate layer, and this over its entire length.

According to an advantageous embodiment, the chamfered profile is conformed according to at least one slope between 0.01% and 50%.

“Slope” means a constant inclination of the chamfered profile or an average slope of a variable inclination of the profile.

According to another possible embodiment, the intermediate layer has one or several cells.

In this embodiment, the cells can be dimensioned and distributed along the intermediate layer according to the variation desired for the flexibility along the intermediate layer.

Advantageously, the intermediate layer can further comprise at least one adhesive layer with the second substrate. Advantageously, the intermediate layer can be of a base of a material chosen from polymers such as:
an epoxide;
an elastomer;
a plastic;
polyurethane;
a composite.

The material of the intermediate layer can be chosen according to the affinities with the material of the adhesive.

Moreover, the first and second layers of the intermediate layer, the adhesive and the adhesive layer are advantageously comprised of the same material chosen from the list hereinabove. Through their material, the layers thus benefit from adhesive affinities together which make it possible to further reinforce the resistance of the bonded assembly.

These layers of the same material can on the other hand have different flexibilities, even variable along the layers.

Advantageously, an interval between the substrates comprises, around the intermediate layer, a seal arranged in such a way as to be compressed by the substrates maintained with respect to one another by the intermediary of the adhesive.

The compressed seal makes it possible to insulate the intermediate layer and adhesive unit from the environment that surrounds the bonded assembly. This insulation provided by the seal preserves this unit in conditions of use that make it possible to guarantee good durability. The material of the intermediate layer and of the adhesive can as such be chosen according to the properties sought and the compositions of the substrates to be maintained with respect to one another, while still retaining confidence in obtaining these properties effectively and sustainably.

In a possible embodiment, one of the substrates can be a rigid element that reinforces the other substrate by gluing via the adhesive.

According to a second aspect, the invention relates to a method of manufacturing an element of a bonded assembly, with the method comprising:
forming a first layer having a chamfered profile,
pouring a material in liquid form into a mould comprising the first layer of the chamfered profile;
forming a second layer via solidification of the poured material, the second layer once solidified being more flexible than the first layer,

the first layer and the second layer together forming an intermediate layer to be placed between two substrates in the bonded assembly.

In a possible embodiment, the first layer is formed on a support consisting of one of the aforementioned substrates.

In a possible embodiment, the liquid material is poured on the first layer by being contained at the periphery by a compressible seal. Once solidified, the flexible material poured then forms the second layer, said second layer is delimited by the seal.

The intermediate layer can be brought by gluing for a rigid connection with the substrates. Other manufacturing techniques can be used as an alternative to the technique hereinabove. The intermediate layer can in particular be integrated into the substrate by gluing using techniques chosen from:
moulding,
machining,
extruding,
or other.

Advantageously, the method can further comprise a step of treating the surfaces of the intermediate layer (CID) following the formation of the first and second layers. This surface treatment makes it possible to improve the adhesive capacities of the intermediate layer with the adhesive and/or the adhesive layer.

The surface treatment of the intermediate layer can be in particular carried out via techniques that are:
mechanical (sanding technique typically);
physical (by laser, flaming, elevation in temperature, UV/ozone exposure, plasma, corona effect or other); or
chemical (adhesion primer for example).

The capacities of adhesion of the intermediate layer with the adhesive layers are particularly improved when the intermediate layer has a polyurethane base.

In another application of a bonded assembly according to the invention, a method is proposed for reinforcing a structure comprising at least one substrate, with the method comprising:
rigidly connecting with a reinforcing substrate an intermediate layer having a variable flexibility along the reinforcing substrate, with the flexibility resulting from a variation in the thickness of at least one material of the intermediate layer, and
maintaining the reinforcing substrate and the intermediate layer on the substrate to be reinforced by the intermediary of an adhesive.

Advantageously, the method can further comprise, during the rigid connection of the rigid element with the substrate, a compression of the seal arranged at an interval of overlapping.

### BRIEF DESCRIPTION OF THE FIGURES

Other characteristics and advantages of the invention shall appear when examining the detailed description hereinafter, and the annexed drawings wherein:

FIG. 1A to 1C show typical example embodiments of a bonded assembly, and show the deformations and shearing stresses conventionally underwent by the adhesive, in particular at its edges;

FIGS. 2A to 2C show embodiments of a reinforcing element bonded to a structure, generating deformations and stresses similar to the examples of FIGS. 1A to 1C;

FIG. 3 shows the change, according to the length in covering of the two substrates of the adhesion interface of the adhesive, of the ultimate force to be applied in order to obtain a rupture of the conventional bonded assembly adhesive;

FIGS. 4A to 4C show examples of a bonded assembly according to the invention, and show the lesser stresses underwent by the adhesive;

FIGS. 5A, 5A′, 5B and 5B′ show examples of bonded assembly according to a first possible embodiment;

FIG. 6 shows an example bonded assembly according to a second possible embodiment; and

FIG. 7 shows a step of manufacture of the bonded assembly according to the invention.

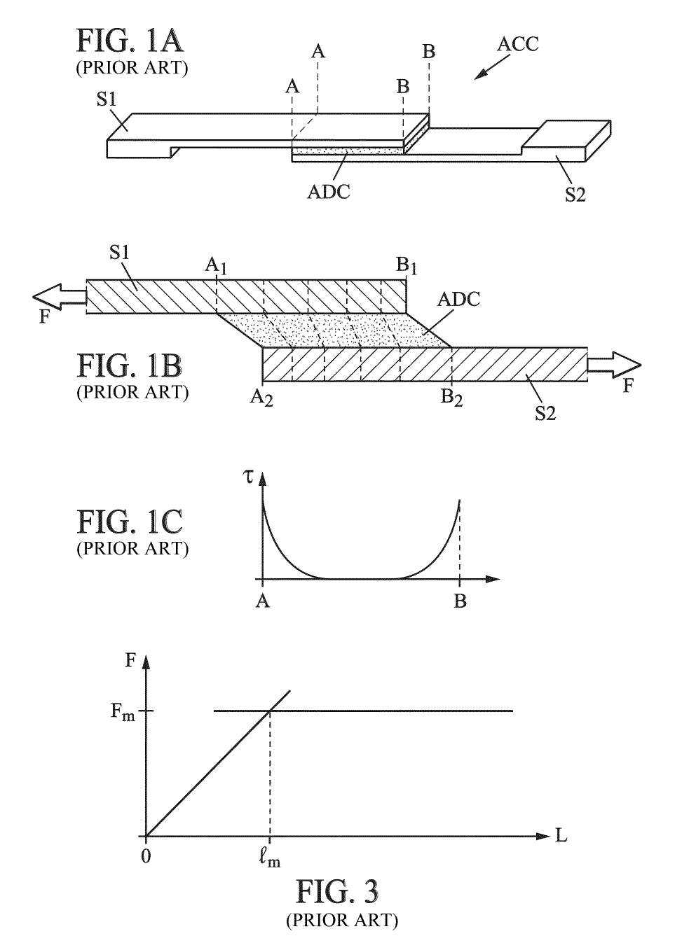

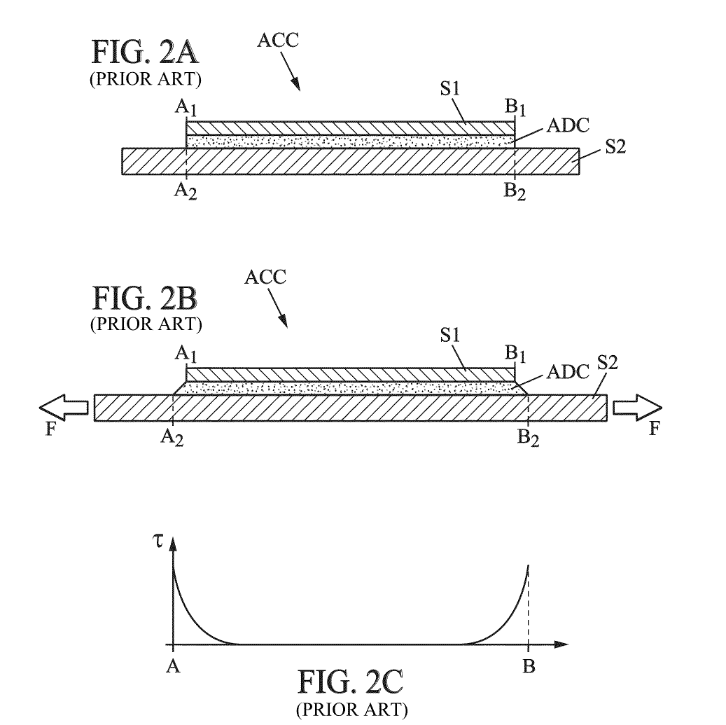

For reasons of clarity, the dimensions of the various elements shown in these figures are not necessarily in proportion with their actual dimensions. In the figures, identical references correspond to identical elements.

### DETAILED DESCRIPTION

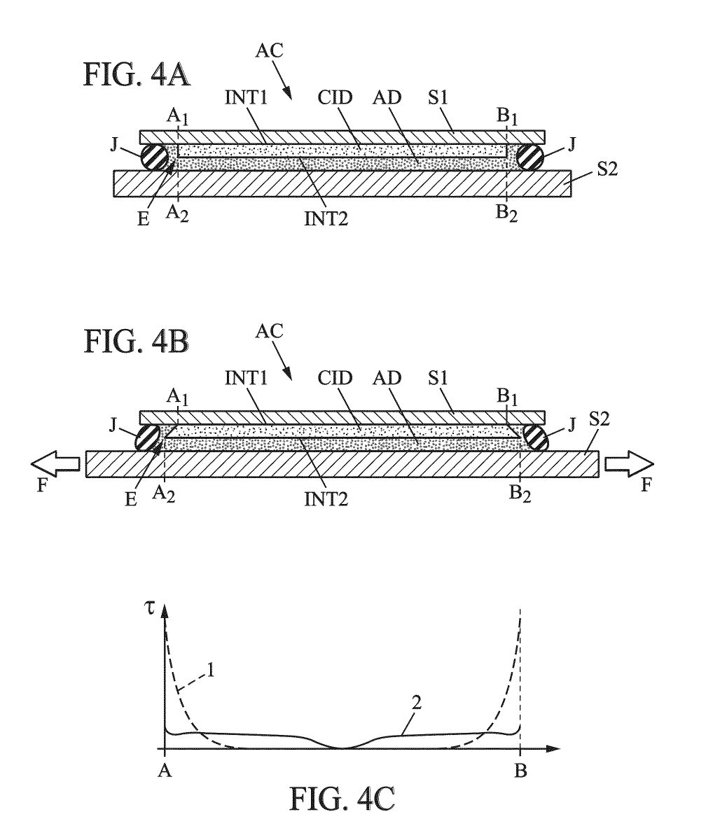

Reference is made to FIGS. 4A to 4C which show examples of a bonded assembly AC according to the invention. The assemblage comprises a first substrate S1 and a second substrate S2.

In the example shown, the first substrate S1 is a reinforcing element intended to repair, protect and/or reinforce a structure comprising the second substrate S2. The reinforcing element can take the form of a plate superposed on a wall of the structure, typically a plate made of metal, composite or any other material with a rigidity that is sufficient to reinforce the structure.

The assembly AC comprises an intermediate layer CID, referred to as “deformation”, and an adhesive AD, which form a unit E. The adhesive AD is arranged between the substrates S1 and S2 and it is intended to rigidly connect them together by the intermediary of the layer CID. The adhesive AD comprises adhesion interfaces with the substrate S2 and the layer CID. The layer CID comprises a first interface for rigidly connecting INT1 with the substrate S1, and a second interface for rigidly connecting INT2 with the adhesive AD. The layer CID has a variable flexibility along the interfaces INT1 and INT2. The marks A and B show the limits of the interfaces INT1 and INT2 of the adhesive AD (the marks A1, B1 and A2, B2 being respectively the marks relating to the interfaces INT1 and INT2).

In this example purely for the purposes of information of the bonded assembly AC, the layer CID is of variable flexibility along the interfaces INT1 and INT2.

The layer CID and the adhesive AD can be made with the same material base. Moreover, the layer and the adhesive can be carried out with densities that are different from this same material in such a way as to confer separate levels of flexibility. The flexibility of the layer CID can in particular have a module of elasticity, also called Young's modulus or rigidity, that is lower than that of the adhesive AD.

The material used can in particular be chosen from the following list of polymers:
an epoxide;
an elastomer;
a plastic;
polyurethane; or
a composite.

During the tests conducted by the inventor, the use of epoxy and polyurethane was particularly effective, in particular when the layer CID and/or the adhesive layers are comprised of several layers. Indeed, the adhesive affinities between layers of epoxy (of the same flexibility or of a different flexibility) confer excellent adhesive capacities between the layers.

Furthermore, a surface treatment can be beneficial in order to improve adhesion, in particular for materials such as polyurethane. The surface treatment can be carried out by the intermediary of techniques such as a technique of sanding the layer, laser treatment, flaming, elevation in temperature, UV rays/ozone, plasma, corona effect, or by adhesion primer for example.

The layer CID with variable flexibility makes it possible to more precisely control the behaviour of the layer faced with the stresses of deformation, in such a way that its absorption capacities are better controlled along its extended form.

A physical description of the “variable flexibility” could be made by characterising this flexibility by a parameter equal to the inverse of the stiffness. The stiffness can be viewed as the product of Young's modulus of the intermediate layer by its section. In light of the primarily shearing stresses to which the invention is addressed, the intermediate layer advantageously has a variable axial flexibility along the first substrate or a flexibility in shearing that is variable.

The adhesive AD can be relatively rigid and have good adhesive capacities:
with the substrate S2, due to its rigidity; and
with the layer CID thanks to the adhesive affinities of their material.

The intermediate deformation layer CID as such makes it possible to improve:
the absorption of the differential deformations at the longitudinal ends of the extended form of the adhesive AD (by the intermediary of the layer CID); and
the general capacities of adhesion to the interfaces INT1 and INT2 with the substrates (by the intermediary of the adhesive AD relieved of the stresses in deformation).

The layer CID with variable flexibility here makes it possible to obtain a controlled behaviour that more uniformly distributes the shearing and peeling stresses generated by the outside forces F applied to the bonded assembly AC. The behaviour in absorption of deformations reached by the unit E of the bonded assembly AC as such makes it possible to reduce, and even suppress, the edge effects that usually occur on the adhesive AD in prior art.

FIG. 4C shows the shearing stresses (τ) underwent by the layer or layers rigidly connecting the two substrates S1 and S2, with:
a curve 1 representing the stresses underwent by a conventional adhesive,
a curve 2 representing the stresses underwent by the unit E with the layer CID with variable flexibility along its interfaces for rigidly connecting INT1 and INT2.

It is observed that the unit E (curve 3) more effectively absorbs the differential deformations at the edges than the embodiments corresponding to curves 1 and 2. The peaks in value of the shearing stresses τ indeed disappear, replaced with stresses that are less and that are more uniformly distributed between the marks A and B. The transfers of forces are as such distributed more uniformly one more extended zones, avoiding the consequences that are inherent with strong localised stresses usually at the edges.

A seal J can furthermore be arranged between the substrates S1 and S2, on an interval of overlapping of the substrates S1 and S2. The interval of overlapping is defined by the space between the substrates, beyond the interfaces INT1 and INT2 with the layer CID. In the interval of overlapping, which can be filled with adhesive AD, it is then understood that the substrate S1 is opposite the substrate S2.

The seal J can be installed all around the unit E, in particular when the substrates S1 and S2 extend over either side of the interfaces INT1 and INT2.

The seal J arranged in the interval of overlapping is in particular confirmed in such a way as to be compressed by the substrates S1 and S2 rigidly connected by the adhesive. The unit E maintains the separation between the substrates S1 and S2 in such a way that the substrates permanently apply a compression force on the seal J. The seal J compressed as such makes it possible to protect the adhesive from the environment outside the bonded assembly AC.

When the seal J entirely surrounds the unit E, the adhesive AD and the layer CID are confined in a sealed space delimited by the substrates S1 and S2 as well as the seal J. It is understood that because of this the adhesive and the intermediate layer can be preserved in ideal operating conditions (no aggression from the outside environment), which improves the durability of their elastic and adhesive capacities. The performance desired for the unit E are as such sustainably retained, and this even if the bonded assembly is installed in a harsh environment, such as a marine environment for example.

In a particularly advantageous embodiment, the layer CID can be carried out in such a way that its capacities of deformation absorption are high in the vicinity of the edges of the adhesive.

In this way, the absorption function of the differential deformations is correctly provided at the edges, zones which, as described hereinabove, are generally the most sensitive due to their exposure to peaks in shearing and peeling stresses.

For the structural reinforcement, the bonded assembly AC can be installed on a structure that comprises the substrate S2 to be reinforced (such as an oil platform module for example) via a rigid element such as the substrate S1. The method for installing the bonded assembly AC then comprises at least the steps of:
rigidly connecting on the substrate S1 of the layer CID, said layer CID has a variable flexibility along the substrate S1, and
maintaining by the intermediary of the adhesive AD of the substrate S2.

When the unit E rigidly connects the rigid element S1 and the substrate S2, a compression of the seal J should be provided arranged in the interval of overlapping.

According to other possible configurations, note that the rigid element S1, the layer CID and the adhesive AD can adopt the shape of the substrate S2 when the latter forms an angle or a curved surface.

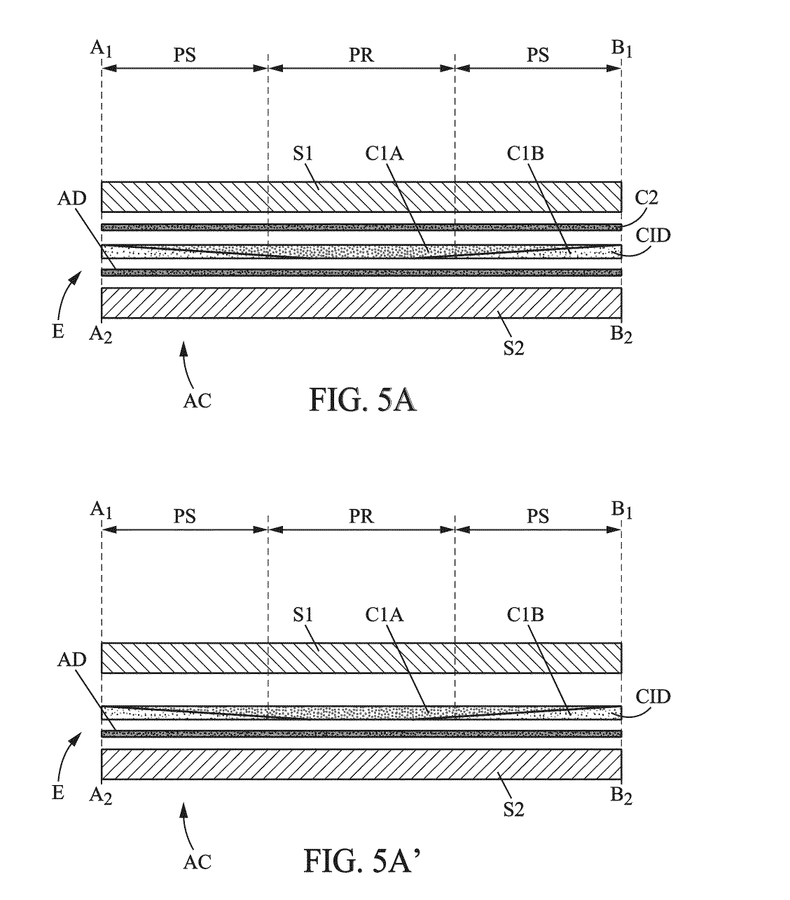

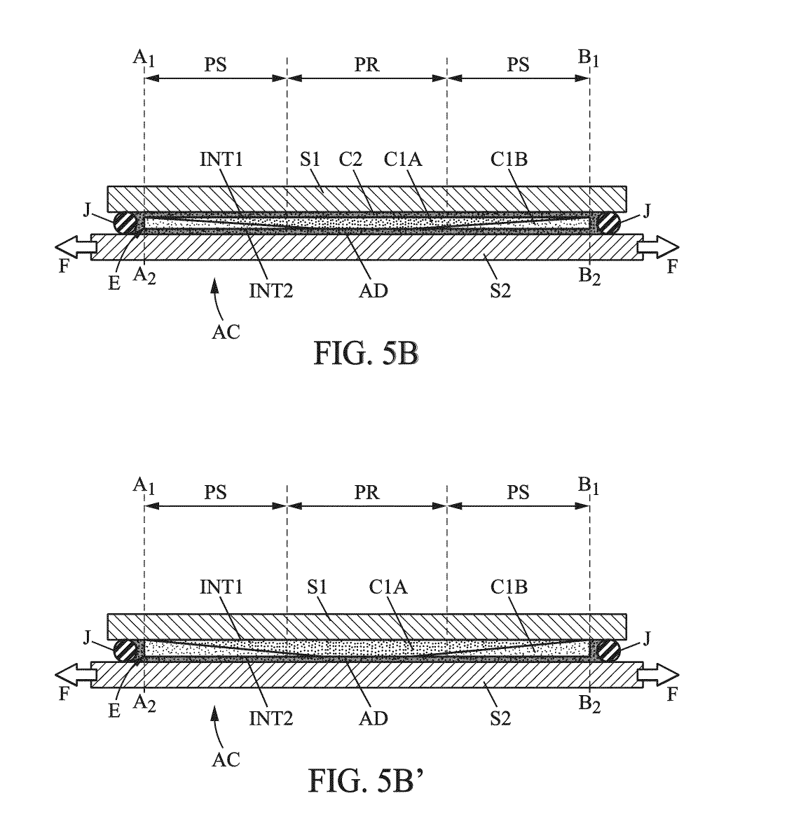

Reference is now made to FIGS. 5A and 5B which show a first embodiment of the intermediate layer with variable flexibility. The layer CID comprises a first rigid layer C1A, and a second flexible layer C1B. The materials of the layers CIA and C1B can be identical (as explained hereinabove) but with different levels of flexibility (by the intermediary of a different material density for example).

Typically, the layer C1A can be of a rigidity between 1,000 and 300,000 MPa while the layer C1B can be of a rigidity between 1 and 1,000 MPa.

The layers C1A and C1B can have variable thicknesses in such a way as to confer to the layer CID a variable and progressive flexibility along the extended form of the layer CID.

The variation in thickness of the layers C1A and C1B can be carried out according to a chamfered profile and an additional profile of the chamfered profile.

In a possible configuration, the layer C1A adopts the chamfered profile and the layer C1B is carried out according to an additional profile of the profile of the layer C1A. Since the layer C1A is more rigid than the layer C1B, it is understood that, in this configuration example, the layer CID comprises:
two flexible portions PS, each one respectively on one of the longitudinal ends of the extended form of the layer CID; and
a rigid portion PR between the longitudinal ends.

Furthermore, the unit can comprise a layer C2 arranged at the interface INT1 with the substrate S1. The layer C2 is for example a layer of epoxy with a rigidity of about 3,000 MPa. The rigidity of the layer C2 provides good adhesion conditions at the interface for the rigid connection between the layer CID and the substrate S1.

Note that the chamfered profile can be provided according to different slopes. By way of example, the slope of the chamfered profile can be a slope between 0.01% and 50%, preferably between 0.01% and 20%. The slope can correspond to a constant inclination of the chamfered profile or to an average slope with a variable inclination of the profile.

Moreover, according to another possible configuration, the variation in thickness of the first and second layers C1A, C1B of the layer CID can be carried out according to other shapes, for example a curved shape, according to the variation in flexibility desired for the adhesive.

Reference is now made to FIGS. 5A′ and 5B′ that show another example wherein the layer CID is directly rigidly connected with one of the substrates (here the substrate S1). This direct rigid connecting can be carried out in particular when the intermediate layer is made of layers of rigid materials such as glass or carbon fibres pre-impregnated with resin and of a resin that can be poured on the substrate.

According to an embodiment compatible with the method described hereinafter, the intermediate layer CID can be constituted of a single material of variable thickness, for example a layer made of a homogeneous material of which the thickness decreases progressively from a first portion PR to second portions PS located at the longitudinal ends of the layer CID and more flexible than the first portions.

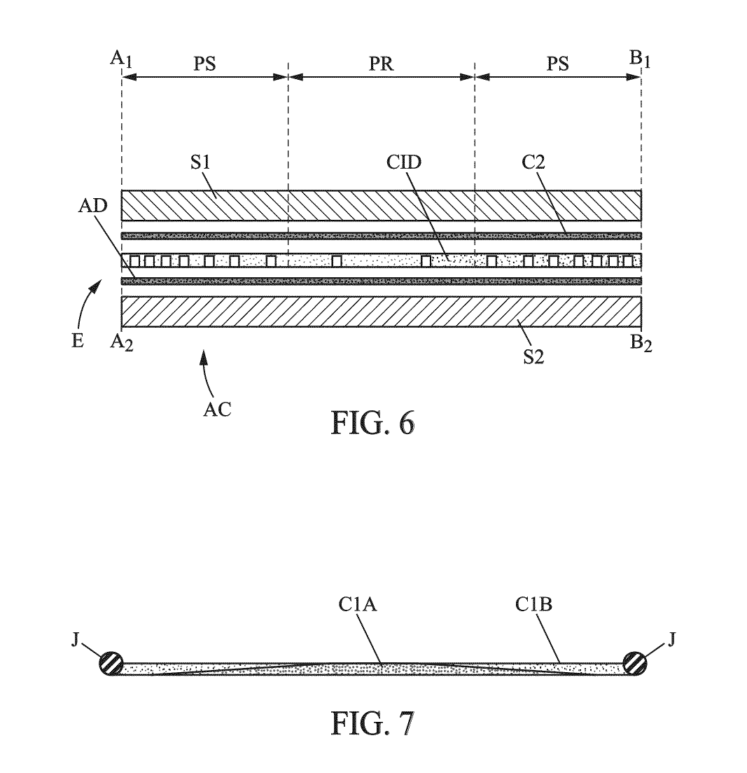

Reference is made to FIG. 6 which shows another possible embodiment of the adhesive AD. The variable flexibility of the layer CID is obtained by forming cells of suitable shape, dimensioning a distribution in order to obtain a desired flexibility along the layer CID. This embodiment of the layer CID also makes it possible to locally control the absorption of deformations, in particular with a view to smooth the profile of the shearing and peeling stresses.

The layer CID is conformed so that the cells are more particularly located in the vicinity of the longitudinal ends of the extended form of the adhesive AD. In this way, the layer CID is comprised of less material on its edges, which makes it more flexible on the portions PS, and more rigid on the portion PR, distributing more uniformly the shearing and peeling stresses along the adhesive AD.

In this embodiment, the cells can be machined in the layer CID as early as the manufacturing phase of the layer.

FIG. 7 shows a step of the method of manufacturing an intermediate deformation layer having a variable flexibility according to the embodiment of FIGS. 5A, 5A′, 5B and 5B′. In this figure, the layer CID is shown according to a turned over view (“head at the bottom”) with respect to the layer CID in the preceding figures. At this step of the method, the layer C1A was formed by superposition of layers of rigid material such as glass or carbon fibres pre-impregnated with resin (according to a technique of depositing via draping for example) and a flexible material, in its liquid form, was poured into a mould wherein are arranged beforehand the seal J and the layer C1A. The seal J makes it possible in particular to contain the liquid poured in order to form the second layer C1B of the layer CID. The seal J can moreover be deformed by compression during the operation of the manufacture of the layer CID. After solidification of the flexible material poured, the solidified material constitutes the layer C1B. The flexible material that then forms the layer C1B can be a layer of epoxy of low density. During the manufacture, the successive superposition of layers constituting CA1 makes it possible to precisely define the variations in thickness of the layer, in such a way as to describe an ideal profile for controlling the distribution of the shearing and peeling stresses within the layer CID.

The method can of course be implemented in such a way that the layer C1A is rigidly connected to either the first substrate S1 or to the second substrate S2.

The techniques for manufacturing the layer CID are implemented directly by the production units and do not require any additional operations such as those described hereinabove relating to prior art.

A surface treatment of the layer CID can show to be beneficial in order to improve the adhesion with the adhesive AD and the layer C2.

Moreover, other manufacturing techniques can be implemented in order to obtain the layer CID (moulding, machining, extruding, etc.).

Furthermore, note that in order to improve the results conferred by the bonded assembly proposed, an increase in the anchoring length can imply more useful length. As such, the bonded assembly is particularly suited to bonded assemblies and reinforcements that convey substantial efforts and that benefit from large contact surfaces (i.e. long adhesion interfaces).

Note that the applications of the bonded assembly according to the invention can be highly varied. The following can be mentioned, for example:
the connections for support of a new element on a marine or maritime installation, in particular an oil installation;
the connections for support of a new element to be placed under water, for example on the shells of an oil platform;
the temporary connections for installation on an offshore installation;
the structural reinforcements (wall spans, beam, post or other);
repair of a damaged structural zone (typically by corrosion);
repair of pipes, including undersea;
repair, reinforcement and/or connection on industrial structures, aircraft, vessels, vehicles or other.

Of course, this invention is not limited to the embodiments described hereinabove by way of example and they extend to other alternatives. As such, according to another embodiment, the layers comprising the intermediate deformation layer can comprise for example a chamfered profile wherein cells are furthermore provided. Such an embodiment of the bonded assembly can in particular make it possible to refine the control of the behaviour in deformation of the adhesive, in particular at the edges.

1-15. (canceled)

16. A bonded assembly comprising at least:
a first substrate,
a second substrate,
an intermediate layer rigidly connected to the first substrate and having a variable flexibility along the first substrate, with the variable flexibility resulting from a variation in the thickness of at least one material of the intermediate layer,
an adhesive between said intermediate layer and the second substrate.

17. The bonded assembly according to claim 16, wherein the flexibility of the intermediate layer is progressively variable along the first substrate.

18. The bonded assembly according to claim 17, wherein the intermediate layer is of a homogeneous material.

19. The bonded assembly according to claim 16, wherein the intermediate layer has two longitudinal ends, the intermediate layer comprising at least:
a first portion arranged at least at one of the longitudinal ends; and
a second portion that is more rigid than the first portion, between the longitudinal ends.

20. The bonded assembly according to claim 16, wherein the intermediate layer comprises at least:
a first layer and
a second layer that is more flexible than the first layer; with the first and second layers being of a variable thickness along the intermediate layer.

21. The bonded assembly according to claim 20, wherein the first layer is of a rigidity between 1000 and 300,000 MPa.

22. The bonded assembly according to claim 20, wherein the second layer is of a rigidity between 1 and 1000 MPa.

23. The bonded assembly according to claim 20, wherein the variation in thickness of one of the first and second layers follows a chamfered profile, and the variation in thickness of the other of the first and second layers follows an additional profile of said chamfered profile.

24. The bonded assembly according to claim 23, wherein the chamfered profile is conformed according to at least one slope between 0.01% and 50%, more preferably between 0.01% and 20%.

25. The bonded assembly according to claim 16, wherein the intermediate layer has one or several cells.

26. The bonded assembly according to claim 16, wherein an interval between the substrates comprises, around the intermediate layer, a seal arranged in such a way as to be compressed by said substrates maintained with respect to one another by the intermediary of the adhesive.

27. A method for manufacturing an element of a bonded assembly, with the method comprising:
forming a first layer presenting a chamfered profile,
pouring a material in liquid form into a mould comprising the first layer of the chamfered profile;
forming a second layer via solidification of the material poured, with the second layer once solidified being more flexible than the first layer,
the first layer and the second layer together forming an intermediate layer to be placed between two substrates in the bonded assembly.

28. The method for manufacturing according to claim 27, wherein the first layer is formed on a support consisting in one of said substrates.

29. The method for manufacturing according to claim 27, wherein the liquid material is poured on the first layer by being contained in the periphery by a compressible seal.

30. The method for manufacturing according to claim 28, wherein the liquid material is poured on the first layer by being contained in the periphery by a compressible seal.

31. A method for reinforcing a structure comprising at least one substrate to be reinforced, with the method comprising:
rigidly connecting with a reinforcing substrate an intermediate layer having a variable flexibility along the reinforcing substrate, with the variable flexibility resulting from a variation in the thickness of at least one material of the intermediate layer, and
maintaining the reinforcing substrate and the intermediate layer on the substrate to be reinforced by the intermediary of an adhesive.
